(19) United States
(12) Patent Application Publication
(10) Pub. No.: US 2026/0331627 A1
(43) Pub. Date: Oct. 22, 2026

(54) Integrated Battery Heating System

(71) Applicant: Textron Aviation Inc., Wichita, KS (US)

(72) Inventor: Andrew Harris Cramb, Wichita, KS (US)

(21) Appl. No.: 19/184,460

(22) Filed: Apr. 21, 2025

(51) Int. Cl. H01M 10/654; H01M 10/04; H01M 10/48; H01M 10/615; H01M 10/63; H01M 10/6571; H01M 50/588

(52) U.S. Cl. CPC H01M 10/654; H01M 10/0431; H01M 10/486; H01M 10/615; H01M 10/63; H01M 10/6571; H01M 50/588

(57) ABSTRACT

An integrated battery heating system configured to provide heat and measure the temperature of a battery cell structure. The system includes a heating element and a temperature measurement device disposed onto a layer of the battery cell structure and configured to directly heat and measure the temperature of the battery cell structure. The heating element and temperature measurement device are electrically connected to contact terminals configured to receive energy and power the heating element and temperature measurement device.

### BACKGROUND OF THE INVENTION

### 1. Field

The disclosed embodiments relate generally to the field of rechargeable batteries. More specifically, the disclosed embodiments relate to the field of heating a rechargeable battery.

### 2. Description of the Related Art

It is known to have a battery heating device. U.S. Patent Application Publication No. 2023/0344029 to Rastegar discloses a system for battery electrolyte temperature maintenance. Rastegar discloses changing the temperature of a battery electrolyte using alternating current (AC). A battery may be heated when AC current is applied to the battery and the frequency of the AC current causes a low impedance capacitor to behave as if the capacitor was shorted. This enables the AC current to pass through resistors and heat the battery core.

U.S. Patent Application Publication No. 2002/0068202 to Gebhardt et al. discloses a fuel cell battery with a heater element. The heater element is configured as a coiled wire with a line which connects the heater element to an energy source. The heater element can be integrated as a wire in the center of the electrolyte to heat the electrolyte directly.

U.S. Patent Application Publication No. 2021/0028509 to Su et al. discloses a rechargeable battery with an anode, cathode, and an electrolyte disposed therebetween. A temperature sensor is configured to measure an internal temperature of the battery. A heat spreader element has an end connected to an electrode terminal of the battery cell which is powered by connecting the electrode terminal in contact with an external heat source.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages will be apparent from the following detailed description of the embodiments and the accompanying drawing figures.

In some embodiments, the techniques described herein relate to an integrated battery heating and temperature measuring system including: a battery having a battery cell structure housed within a battery shell, the battery cell structure including: a separator, an anode, a cathode, an electrolyte, a heating element, and a temperature measurement device, wherein the heating element and the temperature measurement device are disposed onto the separator; a heating element contact terminal and a temperature device contact terminal disposed onto an outer surface of the battery shell wherein the contact terminals are electrically connected to the heating element and the temperature measurement device, respectively; and when energy is supplied to the contact terminals, the heating element provides heat for internally warming the battery cell structure and the temperature measurement device detects an internal temperature of the battery cell structure.

In some embodiments, the techniques described herein relate to a system wherein the heating element and the temperature measurement device are adhered to the separator with an adhesive.

In some embodiments, the techniques described herein relate to a system wherein the separator includes a microporous material.

In some embodiments, the techniques described herein relate to a system wherein the heating element contact terminal and the temperature device contact terminal are each exposed on an external surface of the battery shell thereby enabling direct contact with external circuitry interfaces.

In some embodiments, the techniques described herein relate to a system wherein the heating element contact terminal includes substantially circular halves configured around a circumference of a positive battery terminal, and the temperature device contact terminal includes substantially circular halves configured around a circumference of a negative battery terminal.

In some embodiments, the techniques described herein relate to a system including a first spacer disposed in between the circular halves of the heating element contact terminal and a second spacer disposed in between the circular halves of the temperature device contact terminal.

In some embodiments, the techniques described herein relate to a system wherein the first spacer is configured to align the battery with the external circuitry interfaces in a battery holder and prevent the positive battery terminal from contacting the heating element contact terminal, and the second spacer is configured to prevent the negative battery terminal from contacting the temperature device contact terminal.

In some embodiments, the techniques described herein relate to a system wherein the temperature measurement device is a resistive temperature detector.

In some embodiments, the techniques described herein relate to a method for manufacturing a battery having an internal battery heating system and an internal temperature measurement system, the method including: disposing a heating element and a temperature measurement device onto a surface of a separator; assembling a battery cell including: an anode, a cathode, the separator and an electrolyte, wherein the heating element and the temperature measurement device are disposed onto the surface which faces either of the anode or the cathode; and disposing contact terminals onto an external surface of the battery wherein the contact terminals are electrically connected to the heating element and the temperature measurement device.

In some embodiments, the techniques described herein relate to a method including rolling the separator having the heating element and the temperature measurement device, the anode, and the cathode to form the battery cell.

In some embodiments, the techniques described herein relate to a method including Z-folding the separator having the heating element and the temperature measurement device, the anode, and the cathode to form the battery cell.

In some embodiments, the techniques described herein relate to a method including stacking the separator having the heating element and the temperature measurement device, the anode, and the cathode to form the battery cell.

In some embodiments, the techniques described herein relate to a method including using an additive manufacturing technique to grow the heating element and the temperature measurement device onto the separator.

In some embodiments, the techniques described herein relate to a method including disposing a plurality of temperature measurement devices onto the separator and electrically connecting the plurality of temperature measurement devices together such that an expected resistance of the battery may be measured.

In some embodiments, the techniques described herein relate to a method including disposing the contact terminals in pairs onto opposing ends of the battery wherein a first pair is on an end near a positive battery terminal and a second pair is on an end near negative battery terminal.

In some embodiments, the techniques described herein relate to a method including disposing a first pair of external circuitry interfaces and a second pair of external circuitry interfaces onto opposing ends of a bottom side of a battery holder such that electrical connectivity is established when the pairs of contact terminals directly contact the first and second pairs of external circuitry.

In some embodiments, the techniques described herein relate to a method for heating a battery and measuring an internal temperature of the battery, the method including: heating a battery cell structure having a heating element, wherein the battery cell structure includes an electrolyte and layers including an anode layer, a separator layer, and a cathode layer, wherein the heating element is disposed onto the separator layer, and; measuring a temperature of the battery cell structure with a temperature measurement device wherein the temperature measurement device is disposed onto the separator layer.

In some embodiments, the techniques described herein relate to a method including electrically connecting the heating element and the temperature measurement device to respective contact terminals, wherein the contact terminals are exposed on an external surface of the battery.

In some embodiments, the techniques described herein relate to a method including aligning each of the contact terminals for electrically coupling with external circuitry interfaces such that the electrical coupling enables operation of the heating element and the temperature measurement device, respectively.

In some embodiments, the techniques described herein relate to a method including controlling the temperature of the battery based upon temperature information detected by the temperature measurement device.

### BRIEF DESCRIPTION OF THE SEVERAL VIEWS OF THE DRAWINGS

Illustrative embodiments are described in detail below with reference to the attached drawing figures, which are incorporated by reference herein and wherein:

FIG. 1A is a perspective view of a battery with an integrated battery heating system in accordance with embodiments of the present disclosure;

FIG. 1B is another perspective view of the battery of FIG. 1A;

FIG. 1C is a perspective view of the battery of FIG. 1A having pairs of contact terminals;

FIG. 1D is a partially exploded view of the battery of FIG. 1A with the pairs of contact terminals of FIG. 1C removed;

FIG. 2A is a cross-sectional view of a cylindrical battery cell with an integrated heating system in embodiments;

FIG. 2B is a cross-sectional view of a prismatic battery cell with the integrated heating system in embodiments;

FIG. 2C is a cross-sectional view of a stacked battery cell with the integrated heating system in embodiments;

FIG. 3 is a top view of a separator layer integrated with the heating system in embodiments;

FIG. 4 is a method flow for manufacturing an integrated battery heating system;

FIG. 5 is a method flow for heating a battery with an integrated battery heating system;

FIG. 6 is a perspective view of a battery holder; and

FIG. 7 is a perspective view of another battery holder.

The drawing figures do not limit the invention to the specific embodiments disclosed and described herein. The drawings are not necessarily to scale, emphasis instead being placed upon clearly illustrating the principles of the invention.

### DETAILED DESCRIPTION

The following detailed description references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the invention. The following detailed description is, therefore, not to be taken in a limiting sense. The scope of the invention is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the technology can include a variety of combinations and/or integrations of the embodiments described herein.

Embodiments disclosed herein provide a system and a method for an integrated battery heating system. A rechargeable battery oftentimes requires the battery cell structure to be in a specific temperature range while being used or being charged. Current systems are configured to provide external heating and monitoring of the battery cell structure temperature to keep the structure in the specified range. When heating and measuring the temperature of the battery from outside the battery cell structure, as done in current systems, interpolation and best-guess estimation of heat energy can be applied to measure the heat energy of the cell. Embodiments disclosed herein provide a battery heating system which allows for the temperature of the battery cell structure to be measured directly and the battery cell structure to be heated directly. This is advantageous over current systems because direct heating and temperature measurement of the battery cell structure allows for quicker and more efficient heating, and more accurate temperature measurement.

The integrated battery heating system of the present disclosure allows for the direct heating and direct temperature measurement of a battery cell structure. In embodiments, a heating system including a heating element and a temperature measurement device is internally integrated into the battery cell structure of a battery. The heating element and the temperature measurement device each have connection ends which terminate external of the battery cell structure which allows for connection to the internally integrated components of the heating element and temperature measurement device. In this way heating control and temperature measurement may be provided directly to an electrolyte of the battery cell structure for temperature control. This may substantially optimize battery cell charging and provide protection for the cell throughout the cell charging process

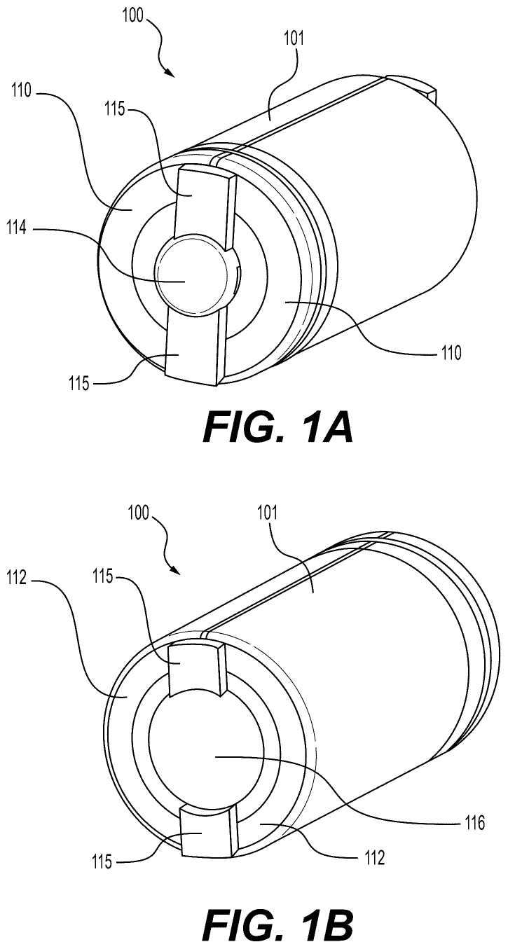

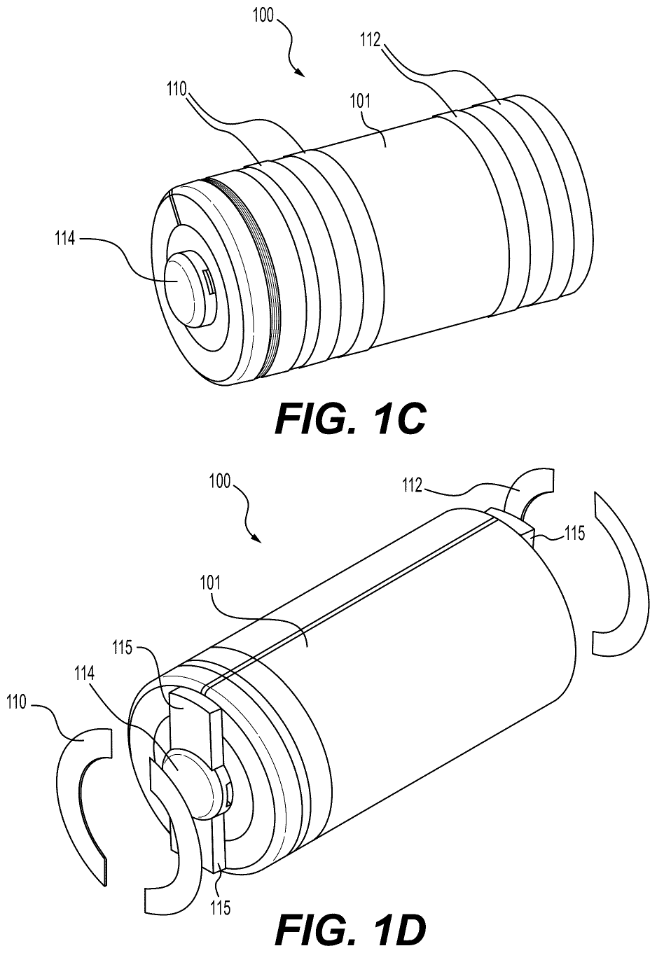

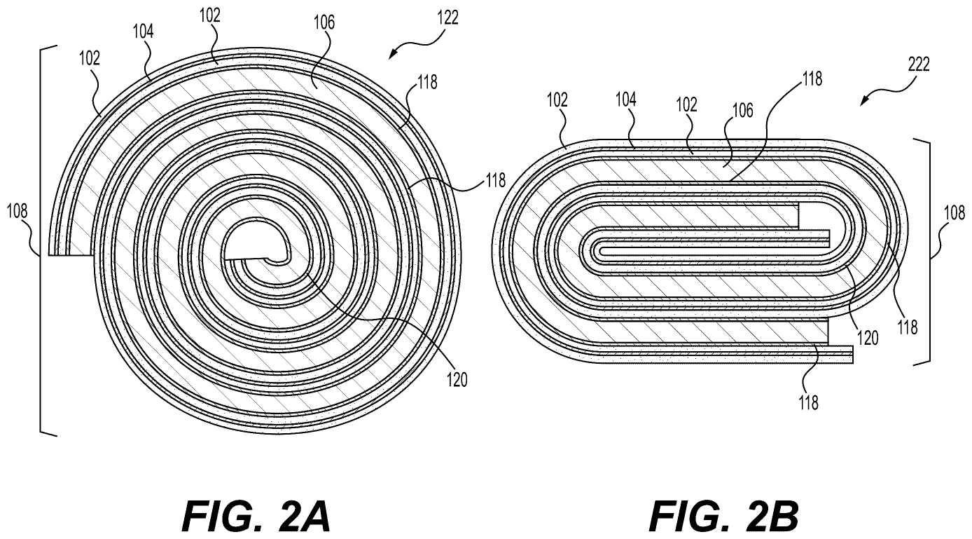

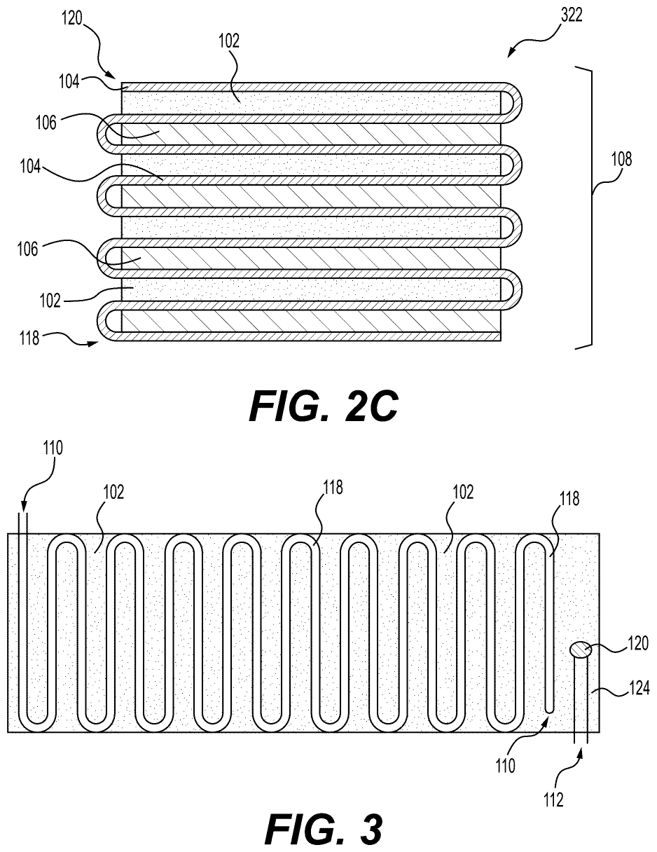

With reference to FIGS. 1A-5 a battery 100 with an integrated heating element 118 and an integrated temperature measurement device 120 is shown and described. In embodiments, the battery 100 includes a shell 101 which forms the outer surface of the battery 100. With reference to FIGS. 2A and 2B, the battery 100 includes a battery cell structure 122 including a separator 102, an anode 104, a cathode 106, an electrolyte 108, a heating element 118, and a temperature measurement device 120. The heating element 118 and the temperature measurement device 120 may be disposed onto or grown onto the separator 102 such that they are each integrated into the battery cell structure 122 in between the separator 102, anode 104, and cathode 106. The heating element 118 is configured to heat the battery 100 and the temperature measurement device 120 is configured to detect the temperature of the battery 100.

In embodiments as shown in FIGS. 1A and 1B, the cylindrical shell 101 covers the separator 102, anode 104, and cathode 106. In embodiments, the electrolyte 108 is disposed throughout the battery cell structure 122 and may be in a liquid form which fills the inner volume of the battery cell structure 122 and chemically joins the anode 104 and cathode 106 together. In embodiments, the heating element 118 includes a heating element contact terminal 110 and the temperature measurement device 120 includes a temperature device contact terminal 112 configured with positive and negative battery terminals 114 and 116 positioned on opposing ends of the battery 100. In FIG. 1A, the heating element contact terminal 110 is configured with the positive battery terminal 114, and in FIG. 1B, the temperature device contact terminal 112 is configured with the negative battery terminal 116. In some embodiments, the heating element contact terminal 110 may be configured with negative battery terminal 116 and the temperature device contact terminal 112 may be configured with the positive battery terminal 114.

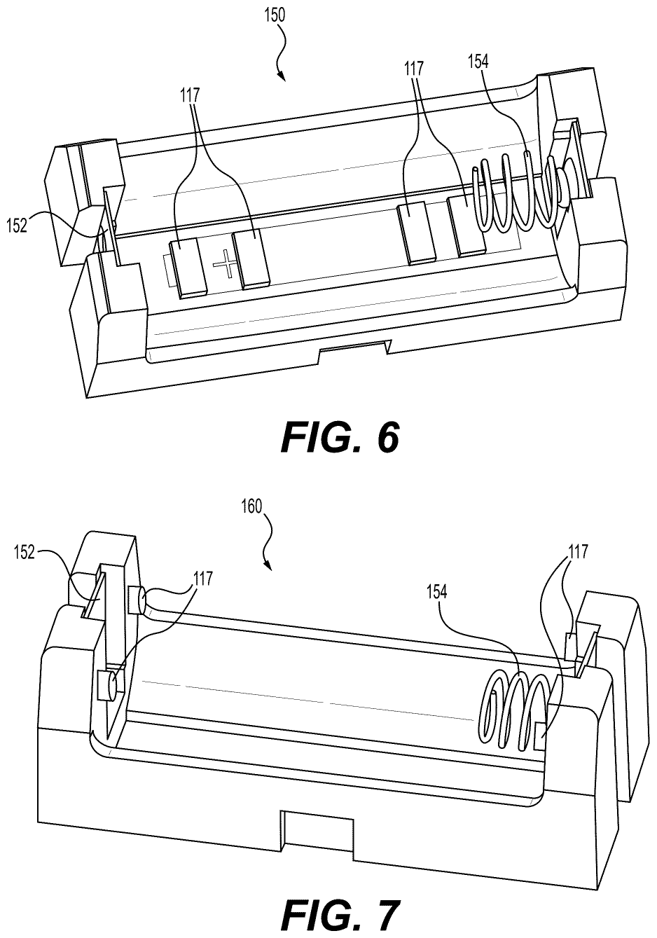

In some embodiments, with reference to FIGS. 1A and 1B, the contact terminals 110 and 112 are configured around the circumference of the circular positive and negative battery terminals 114 and 116. In some embodiments, with reference to FIG. 1C, the heating element contact terminal 210 and temperature device contact terminal 212 are disposed onto the outer surface of the shell 101 and are configured in pairs. In embodiments, the heating element contact terminal 210 and the temperature device contact terminal 212 may be disposed on opposing ends of the shell 101. In some embodiments, a pair on each end may comprise one of each of the heating element contact terminals 210 and the temperature device contact terminals 212. In embodiments, the substantially circular shape of contact terminals 110/210 and 112/212 may be advantageous for allowing the battery 100 to be inserted in various orientations to the battery holders 150 and 160. In embodiments, the heating element contact terminal 110 and temperature device contact terminal 112 may be circular halves separated by a spacer 115. The spacer 115 is configured above and below the positive battery terminal 114 and negative battery terminal 116. In embodiments, the spacers 115 allow for the battery 100 to be aligned within a battery holder 160. The spacers 115 substantially prevent the positive battery terminal 114 and negative battery terminal 116 from contacting the heating element contact terminal 110 or temperature device contact terminal 112. The heating element contact terminal 110/210 provides a connection point for external circuitry interfaces 117 (FIGS. 6 and 7) to electrically couple to heating element 118 integrated within the battery 100 within shell 101 (see FIG. 3). The temperature device contact terminal 112/212 provides a connection point for external circuitry interfaces 117 to connect to the temperature measurement device 120 integrated into the battery 100 within the shell 101 (see FIG. 3). In embodiments, the external circuitry interfaces 117 may be a connection to a cell holder, printed circuit board, or a similar type of device configured to monitor the temperature of the battery cell with temperature sensing device 120 and apply power to the heating element 118 (see FIGS. 6 and 7).

With reference to FIG. 1D, the battery 100 is shown with the heating element contact terminal 110 and temperature device contact terminal 112 removed from the battery 100. In embodiments, the heating element contact terminal 110 and temperature device contact terminal 112 are circularly shaped halves configured to be disposed onto an end of the battery 100 around the positive battery terminal 114 and negative battery terminal 116 (see FIGS. 1A and 1B), or to be disposed over the shell 101 (see FIG. 1C). In some embodiments, the heating element contact terminal 110 and temperature device contact terminal 112 may be two separate halves which are disposed onto the battery 100. In FIG. 1C, a pair of heating contact terminals 210 and a pair of temperature sensor contact terminals 212 are disposed around the shell 101 to connect to external circuitry interfaces 117. In both embodiments, the heating element contact terminal 110/210 and temperature device contact terminal 112/212 are configured to directly contact external circuitry interfaces 117 as shown in FIGS. 6 and 7.

In FIG. 6, the external circuitry interfaces 117 are disposed within a battery holder 150 having a positive connection 152 and a negative connection 154. The external circuitry interfaces 117 are disposed on a bottom side of the battery holder 150 such that heating element contact terminal 210 and temperature device contact terminal 212 which wrap around the shell 101 of battery 100 will align with and directly contact the external circuitry interfaces 117. The external interfaces 117 are spaced apart and may be disposed in opposing pairs on ends of the battery holder 160 such that each of the pairs of heating element contact terminal 110 and temperature device contact terminal 112 contact separate external interfaces. The battery holder 150 may be used to hold battery 100 when the configuration of the pairs of the heating element contact terminal 210 and temperature device contact terminal 212 shown in FIG. 1C is disposed on battery 100.

In FIG. 7, the external circuitry interfaces 117 are disposed within a battery holder 160 having positive and negative connections 152 and 154. The external circuitry interfaces 117 are disposed on opposing sidewalls of the battery holder 160 substantially near the positive connection 152 and negative connection 154. In this way the external circuitry interfaces 117 may directly contact the heating element contact terminal 110 and temperature device contact terminal 112 which are disposed near the positive battery terminal 114 and negative battery terminal 116. The battery holder 160 may be used to hold battery 100 when the configuration of the heating element contact terminal 110 and temperature device contact terminal 112 shown in FIGS. 1A and 1B is disposed on battery 100. In embodiments, the battery 100 may include spacer 115 to prevent the external circuitry interfaces 117 from contacting the contact terminals 110 and 112 and positive battery terminal 114 or negative battery terminal 116 simultaneously when the battery is inserted into the battery holder 160. The spacer 115 may substantially allow the battery to be aligned into the battery holder 160.

In embodiments, external circuitry interfaces 117 allow for the heating element contact terminal 110 and temperature device contact terminal 112 to connect to external devices which provide power for the heating element 118 and temperature measurement device 120. The configuration of the external circuitry interfaces 117 and the substantially circular shape of the heating element contact terminal 110 and temperature device contact terminal 112 allow for simple connection between the terminals and interfaces when a battery 100 is inserted into the battery holders 150 and 160. It should be recognized that numerous other configurations of external circuitry connection to the battery may be employed without departing from the scope of embodiments herein. In some embodiments, the warming of the battery 100 using the heating element 118 may be based upon temperature reading information collected by the temperature measurement device 120. In some instances, the heating element 118 and the temperature measurement device 120 may be communicatively connected together for temperature measurement information to be referenced for temperature control of the battery 100.

With reference to an embodiment shown in FIG. 2A, battery cell structure 122 of battery 100 is shown. In the embodiment shown in FIG. 2A, the battery cell structure 122 is a rolled cylindrical battery cell. The battery cell structure 122 includes the heating element 118 and temperature measurement device 120 (see FIG. 3). In embodiments, the heating element 118 and temperature measurement device 120 may be disposed onto or grown onto the separator 102 to substantially integrate the heating element 118 and temperature measurement device 120 into the battery cell structure 122. The heating element 118 and temperature measurement device 120 may be integrated into the battery cell structure 122 by being rolled into the battery cell structure 122 when the battery cell is manufactured. In this way, the heating element 118 directly contacts the rolled layers (i.e. the separator 102, anode 104, and cathode 106) and the electrolyte 108 of battery cell structure 122. More specifically, the heating element 118 is positioned in between the rolled layers of the separator 102, anode 104, and cathode 106, and the temperature measurement device 120 is positioned near the center of the battery cell structure 122. The heating element 118 may be in between the separator 102 and anode 104 or the separator 102 and cathode 106. In some embodiments, the heating element 118 may be integrated into the battery 100 by being adhered directly against the separator 102. In some embodiments, the heating element 118 and temperature measurement device 120 may be grown onto the separator 102 using additive manufacturing techniques. In this way, the heating element 118 and temperature measurement device 120 are positioned substantially in the center of the battery cell structure 122 to provide direct heating and temperature measurement of the battery cell structure 122. In this way, when power is supplied to the heating element 118, the heating element may radiate heat to the electrolyte 108 and warm the layers of the battery cell structure 122. The heating element 118 warms the battery 100 and may bring the battery into an optimal temperature range for use. When power is supplied to the temperature measurement device 120, the temperature of the electrolyte 108 and battery cell structure 122 may be measured directly because the temperature measurement device 120 is disposed against the separator 102 within the battery cell structure 122.

With reference to FIG. 3, a separator sheet 102 laid flat in an unrolled state is shown with the heating element 118 and temperature measurement device 120 is disposed onto the separator 102. In embodiments, the separator 102 may be approximately ten micrometers to approximately 30 micrometers thick and may be fabricated from a material which is microporous having directionally or randomly oriented fibers, and is chemically stable in reactive environments. In some examples, the separator 102 is fabricated from materials having polyethylene and polypropylene. In embodiments, the heating element 118 winds throughout the separator 102 from one end to the other, and the temperature measurement device 120 is configured at an end of the sheet configured to be the center of the roll. The temperature measurement device 120 is shown in embodiments to be circular but could be a variety of different types of shapes. In some embodiments, a plurality of temperature measurement devices 120 may be disposed throughout the separator 102 and connected in series and parallel to provide information throughout the battery cell structure 122. In this way an expected resistance may be able to be measured. In embodiments, the heating element 118 and temperature measurement device 120 may be adhered directly to the separator 102 using an adhesive. In embodiments, the separator 102 may be formed from an insulative plastic which acts as an insulator between the anode 104 and cathode 106. In embodiments, the heating element 118 may be fabricated from a metallic material and may be formed as a wire. The temperature measurement device 120 is a resistive temperature detector (RTD). In embodiments, the RTD changes its resistance based on the temperature it receives, which allows for the RTD to determine the temperature of the electrolyte 108. In embodiments, the voltage supplied to the heating element 118 may be calculated using known calculations and mathematical formulas. In this way, metals with known resistances per unit length may be supplied with voltage for the electrolyte 108 to be heated. At one end the heating element contact terminal 110 extends out of an edge of the separator 102, and at an opposite end the temperature device contact terminal 112 extends out of an edge of the separator 102. In embodiments, the temperature measurement device 120 is positioned at the center of the battery cell structure 122 and the wires 124 extend directly out of the middle region of the battery cell structure 122. The contact terminals 110 and 112 allow for external circuitry to connect to each of the heating element 118 and temperature measurement device 120.

With reference to another embodiment shown in FIG. 2B, another battery cell structure 222 is shown. In embodiments, the battery cell structure 222 is a rolled prismatic battery cell. Battery cell 222 is substantially ovular or rectangular and may be formed by using a similar rolling process as battery cell structure 122 and includes the separator 102, anode 104, cathode 106, electrolyte 108, the heating element 118, and temperature measurement device 120. The heating element 118 and temperature measurement device 120 are configured to provide direct heating and temperature measurement of the battery cell structure 222.

With reference to another embodiment shown in FIG. 2C, another battery cell structure 322 is shown. In embodiments, the battery cell structure 322 is a stacked prismatic battery cell. The battery cell structure 322 may be manufactured by using a Z-folding method to stack a separator 102, anode 104, cathode 106, the heating element 118, and the temperature measurement device 120. The heating element 118 and temperature measurement device 120 may be integrated into the separator 102, as described above, such that the heating element 118 winds throughout the separator 102 and the temperature measurement device 120 is positioned substantially near the center of battery cell 322 on an inner end of the separator 102. In embodiments, the temperature device contact terminal 112 may extend out of the side of the separator 102 using wires 124 (see FIG. 3). This allows for the temperature device contact terminal 112 to be positioned substantially in the middle of the battery cell 322. The electrolyte 108 may be disposed through the internal volume of battery cell structure 322 and may chemically join the anode 104 and cathode 106 together.

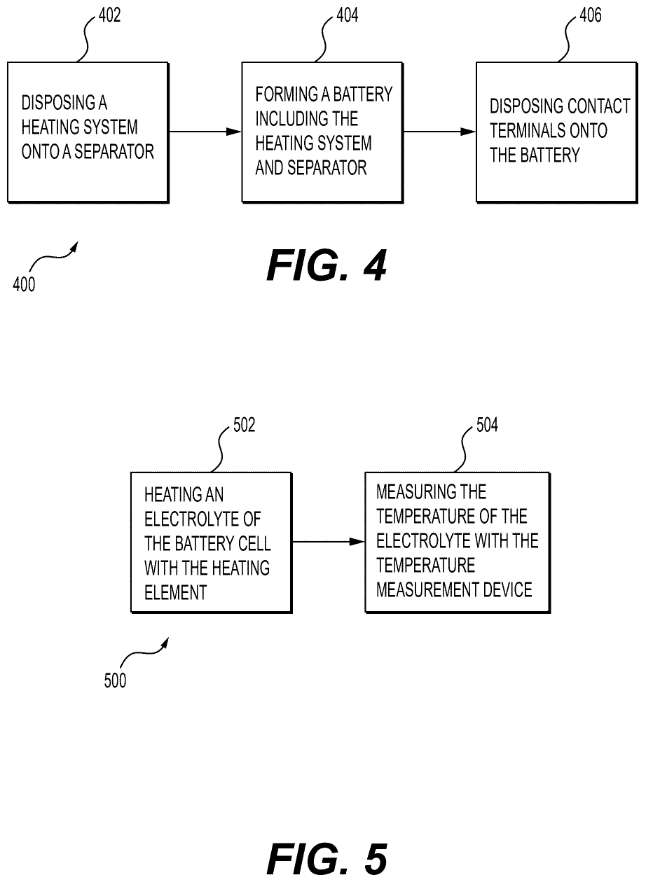

FIG. 4 shows a method 400 for manufacturing a battery with an integrated heating system.

A step 402 comprises disposing a heating element and a temperature measurement device in between an anode, cathode, and separator of a battery cell structure. In embodiments, with reference to FIG. 3, the heating element 118 and the temperature measurement device 120 may be laid onto a separator layer 102. The heating element 118 may be metallic wire and the temperature measurement device 120 may be an RTD. In embodiments, the separator 102 may be fabricated from an insulative plastic material. In some embodiments, the heating element 118 may be adhered to the separator 102, or grown onto the separator 102, possibly using an additive manufacturing technique. In this way, the heating element 118 and temperature measurement device 120 may directly contact the electrolyte 108 which may fill the internal spaces of the battery 100 and chemically joins the anode 104 and cathode 106 together.

A step 404 comprises assembling a battery with the heating system and the separator. In embodiments, any one of battery cells 122, 222, or 322 may be formed and include the separator 102 and the heating element 118 and temperature measurement device 120. In embodiments, the battery cells 122 and 222 are formed using rolling and the battery cell 322 is formed using Z-folding techniques. In some embodiments, the battery cell may be formed by using a stacking technique. In embodiments, the battery cell structure 122, 222, or 322 includes the separator 102, anode 104, cathode 106, and an electrolyte 108. The heating element 118 and temperature measurement device 120 may be integrated into the separator 102 or may be placed onto the separator 102 as shown in FIG. 3, and then rolled or folded into the battery cell structure with the separator 102, anode 104, and cathode 106.

A step 406 comprises disposing contact terminals onto an exterior surface of the battery. In embodiments, the heating element contact terminal 110/210 and temperature device contact terminal 112/212 may be disposed onto any of the battery cells 122, 222, or 322, and may be disposed onto opposite ends of the battery near the positive battery terminal 114 and negative battery terminal 116 (see FIGS. 1A and 1B), or may be disposed onto the shell 101 of the battery 100 (see FIG. 1C). The heating element contact terminal 110/210 and temperature device contact terminal 112/212 may form a substantially circular shape exposed on the outer surface of the battery to directly contact external circuitry interfaces 117 positioned within battery holders 150 and 160.

FIG. 5 shows a method 500 for heating a battery with an integrated heating system.

In a step 502, an electrolyte of the battery cell is heated with a heating element. In embodiments, the heating element 118 is integrated into the battery cell structure 122, 222, and 322 and may apply heat directly to the electrolyte. More specifically, the heating element 118 may be rolled into the layers of the battery cell structure and may be positioned directly against the separator 102. In embodiments, the electrolyte 108 may be a liquid and may fill the internal recesses of the battery 100 in between the separator 102, anode 104, and cathode 106. In this way the electrolyte 108 may chemically join the anode 104 and cathode 106 together.

In a step 504, the temperature of the electrolyte is measured with a temperature measurement device. In embodiments, the temperature measurement device 120 is integrated into the battery cell structure 122, 222, and 322 and may directly measure the temperature of the electrolyte 108. More specifically, the temperature measurement device 120 may be rolled or folded such that it is positioned near the center of the battery cell structure. In some embodiments, the heating element 118 and the temperature measurement device 120 are configured in between the separator 102, anode 104, and cathode 106. In some embodiments, the temperature of the battery 100 may be adjusted based upon a temperature reading provided by the temperature measurement device 120.

Many different arrangements of the various components depicted, as well as components not shown, are possible without departing from the spirit and scope of what is claimed herein. Embodiments have been described with the intent to be illustrative rather than restrictive. Alternative embodiments will become apparent to those skilled in the art that do not depart from what is disclosed. A skilled artisan may develop alternative means of implementing the aforementioned improvements without departing from what is claimed.

It will be understood that certain features and subcombinations are of utility and may be employed without reference to other features and subcombinations and are contemplated within the scope of the claims. Not all steps listed in the various figures need be carried out in the specific order described.

What is claimed is:

1. An integrated battery heating and temperature measuring system comprising:
a battery having a battery cell structure housed within a battery shell, the battery cell structure comprising:
a separator, an anode, a cathode, an electrolyte, a heating element, and a temperature measurement device,
wherein the heating element and the temperature measurement device are disposed onto the separator;
a heating element contact terminal and a temperature device contact terminal disposed onto an outer surface of the battery shell wherein the contact terminals are electrically connected to the heating element and the temperature measurement device, respectively; and
when energy is supplied to the contact terminals, the heating element provides heat for internally warming the battery cell structure and the temperature measurement device detects an internal temperature of the battery cell structure.

2. The system of claim 1, wherein the heating element and the temperature measurement device are adhered to the separator with an adhesive.

3. The system of claim 1, wherein the separator comprises a microporous material.

4. The system of claim 1, wherein the heating element contact terminal and the temperature device contact terminal are each exposed on an external surface of the battery shell thereby enabling direct contact with external circuitry interfaces.

5. The system of claim 1, wherein the heating element contact terminal comprises substantially circular halves configured around a circumference of a positive battery terminal, and the temperature device contact terminal comprises substantially circular halves configured around a circumference of a negative battery terminal.

6. The system of claim 5, comprising a first spacer disposed in between the circular halves of the heating element contact terminal and a second spacer disposed in between the circular halves of the temperature device contact terminal.

7. The system of claim 6, wherein the first spacer is configured to align the battery with the external circuitry interfaces in a battery holder and prevent the positive battery terminal from contacting the heating element contact terminal, and the second spacer is configured to prevent the negative battery terminal from contacting the temperature device contact terminal.

8. The system of claim 1, wherein the temperature measurement device is a resistive temperature detector.

9. A method for manufacturing a battery having an internal battery heating system and an internal temperature measurement system, the method comprising:
disposing a heating element and a temperature measurement device onto a surface of a separator;
assembling a battery cell comprising: an anode, a cathode, the separator and an electrolyte, wherein the heating element and the temperature measurement device are disposed onto the surface which faces either of the anode or the cathode; and
disposing contact terminals onto an external surface of the battery wherein the contact terminals are electrically connected to the heating element and the temperature measurement device.

10. The method of claim 9, comprising rolling the separator having the heating element and the temperature measurement device, the anode, and the cathode to form the battery cell.

11. The method of claim 9, comprising Z-folding the separator having the heating element and the temperature measurement device, the anode, and the cathode to form the battery cell.

12. The method of claim 9, comprising stacking the separator having the heating element and the temperature measurement device, the anode, and the cathode to form the battery cell.

13. The method of claim 9, comprising using an additive manufacturing technique to grow the heating element and the temperature measurement device onto the separator.

14. The method of claim 9, comprising disposing a plurality of temperature measurement devices onto the separator and electrically connecting the plurality of temperature measurement devices together, such that an expected resistance of the battery may be measured.

15. The method of claim 9, comprising disposing the contact terminals in pairs onto opposing ends of the battery wherein a first pair is on an end near a positive battery terminal and a second pair is on an end near negative battery terminal.

16. The method of claim 9, comprising disposing a first pair of external circuitry interfaces and a second pair of external circuitry interfaces onto opposing ends of a bottom side of a battery holder such that electrical connectivity is established when the pairs of contact terminals directly contact the first and second pairs of external circuitry.

17. A method for heating a battery and measuring an internal temperature of the battery, the method comprising:
heating a battery cell structure having a heating element, wherein the battery cell structure comprises an electrolyte and layers including an anode layer, a separator layer, and a cathode layer, wherein the heating element is disposed onto the separator layer, and;
measuring a temperature of the battery cell structure with a temperature measurement device wherein the temperature measurement device is disposed onto the separator layer.

18. The method of claim 17, comprising electrically connecting the heating element and the temperature measurement device to respective contact terminals, wherein the contact terminals are exposed on an external surface of the battery.

19. The method of claim 18, comprising aligning each of the contact terminals for electrically coupling with external circuitry interfaces such that the electrical coupling enables operation of the heating element and the temperature measurement device, respectively.

20. The method of claim 17, comprising controlling the temperature of the battery based upon temperature information detected by the temperature measurement device.
